(19) United States
(12) Patent Application Publication
(10) Pub. No.: US 2024/0338989 A1
(43) Pub. Date: Oct. 10, 2024

(54) PHYSICAL VOTING BALLOT WITH INDIVIDUAL AND UNIQUE NUMBERING/CODING

(71) Applicant: Antonio Serafim DAMIANI, Campo Largo (BR)

(72) Inventor: Antonio Serafim DAMIANI, Campo Largo (BR)

(21) Appl. No.: 18/578,667

(22) PCT Filed: Jul. 21, 2022
(86) PCT No.: PCT/BR2022/050290

§ 371 Date: Jan. 11, 2024

(30) Foreign Application Priority Data
Jul. 25, 2021 (BR) BR 102021014598-6

(51) Int. Cl. G07C 13/00

(52) U.S. Cl. CPC G07C 13/00

(57) ABSTRACT

Physical voting ballot with individual and unique numbering/coding to be used in electoral processes providing full control and inviolability of this process through the controlled flow of the ballot and using various images and information during its flow. Uses different physical models of ballots, with varied cryptographic methods in addition to control systems with proper and isolated libraries and databases. Allow physical and/or electronic recount of votes, ensures the secrecy of the individual voting, transparency and publicity of the scrutiny and prevents various types of supposed vulnerabilities in current voting/electoral systems (used till 2020 in some countries).

### 1. IDENTIFICATION OF EXISTING PROBLEMS IN THE ‘STATE OF THE ART’ WITH THE “VIRTUAL VOTING” CURRENTLY (UNTIL THE YEAR 2020 VOTING IN BRAZIL FOR EXAMPLE) IN USE

There is no physical ballot, only virtual/electronic, so it cannot be verified or visualized.

It does not allow public and transparent recount of votes.

It does not allow an accurate and convincing audit of the electoral process.

It raises doubts about its vulnerability, or not, to malicious systems or processes, illegal manipulation of its data/results, which cannot be healed in an evident way.

It generates institutional insecurity.

Generates the possibility of allegations of fraud by voters (sometimes malicious), not subject to verification without the risk of breaching the confidentiality of the vote.

It does not provide transparency to the electoral process.

Does not publicize the scrutiny (counting and totaling of votes), generating doubtful results in the understanding of some, without the possibility of demonstrating completely the candor of the process.

Does not allow the verification of multiple voting of the same voter in the same election.

### 2. PRODUCT DESCRIPTION AND ITS PROCESS FOR OBTAINING AND USE

This innovative physical voting ballot with embedded technology/coding on each physical ballot, together with its processing and encoding accessories, allows the obtaining of auditable votes, with electronic and or manual totalization, also containing redeemable information; that is, with the possibility of accessing the original vote from each voter-manually or electronically, for the verification of the vote effectively assigned to each candidate.

Its use and purpose are primarily indicated for electoral systems of nations concerned with the secrecy and authenticity of the vote of their voters, public counting and totalization of votes, possibility of physical and electronic recount of the voting and minimizing the possibility of electoral frauds.

This physical voting ballot with individual and unique numbering/coding can be made of paper or other material that allows the incorporation of manual and cryptographic markings (which make them innovative) that allow the visual and electronic reading of it and keep this ballot, already completed and marked, for a long period of time (to be defined according to current legislation/standards) and enabled to be accessed several times over time, either physical or electronically.

Hereinafter for ease of reading and comprehension we will simply refer to this innovative invention previously described/mentioned as:—ballot—, and whenever it comes qualified or complemented by other attributes, we are always referring to the same invention already mentioned.

The ballot contains technologies—chip, barcode, QR code, or others, scattered around or concentrated in one or more locations on its surface, which together or separately will provide, through a calculation algorithm-encrypted (Hash/blockchain encryption or otherwise) or not, a unique number/encoding of identification for that ballot being filled in by the voter in the polling booth.

Its creation flow is an industrial process where industrial equipment and raw materials are needed for making the ‘blank’ physical ballot, and then the ballot, through industrial equipment's, receives encodings and identifications that are physically implanted on or in it. Later in the polling booth, the ballot keeps on being industrially and manually (receiving the marking of the vote by the voter) processed and additionally receiving printed markings electro/mechanically (unique number/code and coded voter vote), to finally, be deposited in the ballot box for completed votes where the information contained therein will be consumed to the extent of its need (recounting, checking, auditing, sampling, feedback for improvements and other purposes) and the ballot itself becomes an industrially processed item of indispensable consumption as it ensures an electoral process reliable and advantageous (see item 6. below).

### 3. SUGGESTED LIST OF EQUIPMENT FOR EACH POLLING STATION

In this example described below, we choose either for security and reliability, the ballot not to be handled (unfolded, filled in then folded again and then manually placed in the ballot box) by the voter:
i) Biometric reader of the voter's finger(s) or hand(s), or other(s) technology(ies) (facial reading and/or reading of the vascular network of the hand of the voter, among others for example) that guarantee the identification of the voter regardless of presentation of an identification document(s), if so is allowed/defined by applicable laws/regulations.
ii) Sealed ballot box, connected to the polling booth, containing ‘blank’ ballots (not yet marked by the voter) being these ballots comprised with technologies-chip, barcode, QR code, or others, scattered or concentrated in one or more places on the voting ballot, which together or separately will provide, through a calculation algorithm-encrypted (Hash/blockchain encryption or other) or not, a unique identification number/coding for that ballot being released mechanically and/or electronically after biometric (or other) identification of the voter for voting in that polling station/booth.
iii) Polling booth where a voting ballot is available ‘blank’ (not yet marked by the voter's himself/herself), through an access window for the voter manually to mark (with a pen or other appropriate marker) his/her vote. Note: after the voter marks his/her choice, on the ballot, the system performs an electronic reading of the same, which is digitally totaled/added in an specific electronic system for such task, with encrypted technologies-Hash/blockchain or other(s), combined with a capture and storing equipment that takes the image of the completed ballot that the voter wrote/filled on the paper ballot, linking the image of that ballot to the unique and exclusive numbering/coding for that voting ballot; while separately in another parallel system, inside the polling booth another equipment captures the image of the face from the voter, linking this image to that current time, and to that electoral section (polling station), being this information stored in a independent and specific digital file for this purpose, never linked to the image of the voter's ballot to ensure the secrecy of the voter's choice(s).
iv) Sealed ballot box (empty at the beginning of the voting process) connected mechanically to the polling booth for reception and storage of votes on paper ballot (or other suitable material) filled in manually by the voter [and that also will be filled in/printed mechanically and/or electronically itself by the polling booth after it has assigned-through identification technologies: barcode, QR code, chip, Hash/blockchain (used together or separately) or other, a number or a unique and exclusive identification for that paper ballot which will be graphically and indelibly marked on the paper ballot where the voter has already marked his vote/choice].

Note that after all identifications of the paper ballot had been filled in manually and mechanically/electronically, the image of the paper ballot is completely captured, stored, and linked to the unique code/numbering assigned to that ballot and then the equipment releases this paper ballot to be deposited in the ballot box for votes already completed (once empty and now with ballots filled in).

Also note that confidentiality of the ballot vote in the sealed ballot box can be obtained from two ways that can be exclusive or complementary: a) with the ballot box having opaque walls (preventing the visual reading of the vote for those who observe it from the outside) and/or b) the ballot suffering a mechanical folding before being placed in this storage polling box of completed ballots.

### 4. SEQUENCE OF SUGGESTED OPERATIONS TO MAXIMIZE THE EXPECTED RESULTS (CONFIDENTIALITY OF VOTING AND MINIMIZATION OF FRAUD USING THE BALLOT)

### i) Preparation of Ballot Boxes, Paper Ballots, and Systems

Prior to the election: each ballot box containing the ‘blank’ paper ballots that will be distributed to voters for voting, receives a seal of identification/validation; each polling booth/electronic voting machine (system responsible for the identification/count of the voter's handwritten vote on paper ballot, capture of the voter's face and graphic print of the voter's vote on the ballot) receives a seal of identification/validation; each ballot box that will store the handwritten (by the voter) ballot together with the additionally electronically printed/marked identification (unique code of the paper ballot and manual vote of the voter read and printed electronically on the ballot) also receives a seal of identification/validation.

IMPORTANT: These identification/validation seals are linked to a single polling booth, and beside having an identification number, it also has an identification chip, or other technology, that allows that polling booth to receive a unique identification number.

### ii) Installation and Testing of Ballot Boxes in the Electoral Section (Polling Station)

During the installation of the electronic polling booth/machines, the person(s) in charge of the polling station must check whether the urns (ballot box with blank ballot papers; electronic polling booth that reads the voter's vote on the paper ballot interacting with the voter; and the ballot storage box for the paper ballots manually and mechanically/electronically marked/completed) that will be used in that polling station are sealed and properly entire. If they are not sealed nor entire, they should be replaced by others that are.

After defining which of the ballot boxes are able to be used, the person in charge of the polling station puts a sticker (with the numbering of that polling station and/or other pertinent identification information) in the several predetermined positions on each of the equipment's (biometric readers, ballot box with blank ballots, polling booth, and ballot box for storage of completed votes), and then with the tablet (mobile phone or other designated equipment, linked or connected to the ballot box system) takes the photos, required by the system, of each equipment with the respective numbered stickers already positioned/glued to the equipment that will be used for voting in that polling station, together with the seal of each of the ballot boxes so that the equipment/systems link the devices (ballot boxes, readers, etc.) to each other linking them to that polling station. Then the members (person in charge and other members) of that polling station proceed to the tests of the batteries in case of power failure, continue with the connections among all the equipment's to ‘run’ the voting initialization and ‘zeroing’ the counting of the polling booth and ‘blank’ ballot box as well as testing the ballot handwriting reading systems, voter's image capturing and box for storing the completed physical ballots (ballots already with handwritten, with the unique identification on the ballot and with the mechanically/electronically printed vote on the ballot). Having tested the systems and the ballot urns/boxes, the expected time for the voting starts is awaited, occasion which the person in charge and other members of the polling station are the first to vote if this is the case.

iii) Voting Beginning

The voter enters the polling room and has his/her identity/biometrics checked by the members of the polling station and/or by the biometric readers (or other voter's identification technology-facial reading for example) of the enclosure. The system checks if that voter actually belongs to that polling station, otherwise the voter is instructed to go to his/her respective electoral polling station previously established.

After the voter identity check, he/she signs his/her presence in the book of presence and receive the stub to confirm his/her presence at the election and the system releases from the sealed box of blank ballots a random ‘blank’ voting ballot, to the voter, that was previously validated for that election (positions and date), within that polling booth. Being that the voter only has access to a ‘window’ of the physical ballot for voting, where he can/should indicate his electoral preference(s).

This ‘blank’ voting ballot, having been previously printed graphically, contains a QR code or a barcode or an ID chip or other marking technology or a combination of all these paper ballot identifiers, which through encryption algorithms and calculations it will assign a unique identification/numbering to that paper ballot in the voting booth.

The unique identification/numbering of the paper ballot is not, nor will it ever be in no event linked to that voter, nor linked to any parameter of identification of the same (biometrics or facial reading), but only to that polling station.

Then the voter enters the polling booth and fills in with a pen the spaces (bins) delimited on the paper ballot, the numbers of the candidates of his/her preference for the various elective positions (president, senator, governor, congressman, state deputy, mayor, councilor or other) belonging to that election.

After completing the manual filling of the paper ballot with the voter's options, the system through the monitor screen asks the voter to press the button ‘finished vote’ confirming that he/she has already completed his/her vote; after confirmation pressed (if the voter do not confirm within XX minutes—to be defined according to current electoral rules/legislation, the system assumes that the voter has already completed/filled in his vote, and the system considers that the vote of that voter is concluded and then moves on) it proceeds to the next steps.

From this moment on, the voter does not have more physical contact with the paper ballot, having only visual contact with it (see *DETAIL 1 for more information).

The system ‘closes’ the window for receiving the voter's signal on the ballot (or move the ballot to an area where the voter only has visual access to it) and proceeds to two electronic markings on the paper ballot: a) a unique identification code on that ballot (bar code. Hash/blockchain code, or other(s)) and, right after a laser/digital (or other) reading technology of the voter's vote, b) prints the voter's vote on the paper ballot (with a barcode or other technology(ies) for marking/identifying) so that the paper ballot is then scanned.

The ballot with the vote filled in has its image captured and stored and then the ballot is deposited in the ballot box with the completed ballots.

### iv) Voting Closure (Suggestion of Procedures)

### Verification/Counting of Votes

An example of the ways for counting and verifying votes can be given as follows:
Electronically totalization of Ballot Boxes/polling station in the polling stations, except in cases of ‘occurrences’ (divergences pointed out by the voter) where in this case the ballot boxes will be checked manually.
After calculating the results, the totalizations of the ballot boxes/stations are sent to the Regional (by county, city, province or state) Electoral Authority for partial sums.
After totalization of the ballot boxes in the Regional Electoral Authority, the partial totals are sent to the Federal Electoral Authority, for the general totalization of votes and publication of the accumulated/consolidated results. (Note: All these steps will depend on the laws and electoral organization of each country.)

### 5. LIST OF THE SYSTEMS AND IT'S STRUCTURES

To guarantee the confidentiality of each vote and minimize the risk of fraud in the voting process, the procedures forecast the use of several separate systems, each one with its own libraries and individualized/separated databases.
i) The first one authenticates the voter's identity (via biometric reading of part(s)) from the voter's body and releases the paper ballot for voting inside the booth (at the database of this system, in addition to biometrics and voter registration data, it is kept stored in which polling station and at what time that voter attended the voting). Optionally it can identify the voter in a traditionally manner with a voter's valid document with photo or what the law forecasts.
ii) The second system confirms that the ballot box with ‘blank’ votes, the polling booth (with its functionalities) and the ballot box, where the completed (manually and digitally/electronically) votes are stored, are all connected, interacting and operative.
iii) The third system captures the image (facial reading) of the voter, the time he was inside the booth and the number of the polling station he was voting at, maintaining a separate database of this information. This optional system allows to deter frauds of the type: the same voter voted several times in the same election, so legal and appropriate measures can be taken.
iv) The fourth system ‘reads’ on the ballot filled in by the voter the written/marked vote by him (her), ‘reads’ the pre-existing markings/encryptions on the ballot and through internal cryptographic algorithm(s) define a unique numbering/encoding for that ballot, sends this information to the printer (mechanical/electronic) in the polling booth, which prints this information on the ballot, and at the same time transmits (votes and unique numbering/encoding on the ballot) to the totalizer inside the ballot box where the votes marked on the ballot by the voter are stored and are linked to the unique number/code of the ballot in the totalization file of the votes of that polling booth. The same system, in parallel, requests through message(s) on the polling booth monitor the confirmation, or not, from the voter for its vote displayed on the screen, then releasing the paper ballot to be deposited in the ballot box for ballots already filled in, informing the members controlling the polling station that the polling booth can receive the next voter.
Note 1: The vote that is electronically ‘read’ and added to the totalizer (electronically encrypted or with another fraud control system) of the polling booth, is kept on a file linked to the unique numbering/coding identification mechanically/electronically printed on the physical ballot so that it's image can be retrieved at any time, and if there is any discrepancy (between what is marked by the voter manually and what is read/identified by the system) the voter can signalize this (pressing a proper button) placing a ‘flag’ on that polling booth for proper recount, and at the same time a warn appears for the members of the polling station on a control panel stating the information of a discrepancy vote and that it will be necessary to register a ‘term of occurrence’ signed by that voter for future measures (improvement/correction of the system or punishment of the voter for false allegation of discrepancy).

DETAILS: After the ‘reading’ through the polling booth of the marked ballot with the handwritten vote of the voter, the equipment fills in mechanically/electronically, on the physical ballot with graphic characters (the ‘reading/identification’ that the system made of the handwritten vote and presents it on the screen of the monitor inside the polling booth through an image containing the picture of each of the candidates voted by the voter next to the image of the numbers written by the voter and identified by the polling booth. At this occasion the voter is asked to confirm these choices, as follows:
If the voter confirms the choices on screen, again the voter is asked whether the mechanically/electronically filled vote on the paper ballot reflects his/her choices in the space on the ballot where he/she marked his/her vote by hand.
If the voter confirms the equality between the filled vote mechanically/electronically and his/her choices filled in by hand on the physical ballot (now containing the unique identification number/code of the ballot, the votes hand marked by the voter and the ‘read’ and computed votes by the system, now also printed in an appropriate space on the ballot) it has its image captured/photographed by the system (remaining the unique number of ballot identification linked to that image of that voting ballot filled in captured in the polling booth, in a database-which in no time is bound to the voter, whether by (used together or separately) it's biometrics or his/her image), and then the paper (physical) ballot already filled in by hand and mechanically/electronically, is mechanically deposited in the sealed ballot box for such purpose (store already completed paper votes).
If the voter does not confirm the equality between manual and electronically filled-in voting, a message will appear on the monitor screen inside the polling booth indicating that if there are similar discrepancies to this in XX % (according to the norms and legislation in force) the ballot box will be recounted manually to confirm the votes, and in the case where the manual recount founds no discrepancy, the voters who pointed out such discrepancy will be subject to the penalties forecasted by the law, and then the voter fill in a term of occurrence (discrepancy between numbers marked and numbers read by the equipment) in his/her polling station.
The voter is again asked to press the ‘divergence’ button on the keyboard of the polling booth (in case the voter has made a mistake, he can press the ‘confirm’ key twice to show that there was a mistake and that in fact the spelled votes mechanically/electronically actually correspond to his/her assigned votes). One warning/counter outside the booth appears on a control panel for the persons in charge of the polling station, and every time the divergence button in the polling booth is pressed the person(s) in charge of the polling station asks that voter to fill in an occurrence term where the voter claims to have verified a discrepancy between his/her manually filled vote and the vote ‘read/identified’ by the polling booth.

IMPORTANT: At no time the physical voting ballot filled by that voter will be linked to him/her in order to preserve the confidentiality of the vote.
NOTE2: The voting ballot filled in by hand and mechanically/electronically contains a unique identification number/code for that ballot (obtained from reading the QR code or barcode or an identification chip or other tagging technology-Hash/blockchain for example, or another, or a combination of all these, marked mechanically/electronically on the paper ballot), which will allow in a later recount the following: a) rescue the image of the completed ballot after its manual and mechanical/electronic filling, to verify if the electronically/mechanically printed vote on the ballot reflects the vote hand marked by the voter; b) in possession of the list of the votes of each ballot tied/linked to the unique number/code of each ballot, it will make possible to check if the votes computed by the totalizer of that polling booth match with each vote indicated by each voter on each hand marked ballot.
NOTE3: In case of any doubt in the recount of votes, it is possible to redeem the image(s) of every vote of a polling station (or all of them) to see which numbers were actually filled in/completed by hand by the voter on the voting ballot. Whenever a paper ballot filled in manually is placed in the reader inside the polling booth, the system captures an image of it which is identified/linked to the unique numbering/coding linked to that physical ballot, allowing a further verification if: a) the mechanically/electronically printed part of the vote actually corresponds to the filled in manually by the voter; and b) if the vote manually filled in by the voter was not altered/erased after being removed from the sealed ballot box containing the completed ballots filled in manually and electronically.

### 6. COMPARATIVE ADVANTAGES OF USING THIS PHYSICAL VOTING BALLOT

i) Makes every voter a potential auditor of the electoral system, giving reliability to the electoral system and allowing its constant enhancement.
ii) Allows, if necessary, the manual recount of votes on paper (or other physical material) and also allows the electronic recount for each ballot box, if necessary, due to the assignment of a unique number/code to each physical ballot.
iii) Allows to check whether the electronic vote reading system really reflects the voter's choices marked on the physical ballot in two ways: through the check made by the voter in the polling booth and afterwards by comparing the marking of the voter on the physical ballot and the marking of the system itself on the physical ballot.
iv) At any time if there is any doubt about the possibility of fraud (afterwards overwritten) on the ballot it is possible to access the original ballot image marked by the voter, through the rescue of the original image completed by the voter, through the redeem in the database image file tied to the unique numbering/coding (assigned through its own algorithm by the polling booth) of each voting ballot, verifying which was in fact the original marked vote of the voter.
v) It is possible to curb abuses of voter(s) who systematically accuse improperly (or not) the system of not being faithful or changing its vote (the polling booth ‘fills in’ a vote that the voter has not entered, or the polling booth screen shows a certain choice of the voter, and another vote goes to the totalization system). Now in this systematic with the use of the physical ballot with unique numbering/coding, the offending voter can be punished with fines/punishments (according to current legislation) through manually conferring the totals in the polling station where divergences were declared regarding improper reading/totalizing of votes, and always preserving the secrecy of the vote.
vi) It is possible to verify if a voter has voted more than once in that polling station or in any other (as it has sometimes been alleged), by capturing the facial image of voters, linking them to the respective voting time inside the polling booth (isolated and separately from the system that captures and store the votes, which guarantees the secrecy of the vote). NOTE: Due to this you can mitigate the occurrences of backlog of votes in the final 15 minutes in some of the polling stations, which are often evidence of elections fraud committed by the members in charge of that polling station or another polling station, who supposedly could vote, or even in fact vote, for voters who do not attend the voting.
vii) The assignment of a unique number/code to each physical ballot allows that, while pointing the code reader equipment to this unique identification code of the physical ballot, we immediately obtain at the monitor screen the image of the vote originally filled in by the voter (at no time does this system allow the identification of the voter's identity, it only links the unique number/code assigned to the physical ballot and its original image when read/scanned by the system in the polling booth).
viii) Maintains the confidentiality of the votes, regardless of systems that may try to recover the vote of this or that voter knowing in advance what time he had voted.
ix) Allows public scrutiny of the votes counting, providing transparency and public knowledge to its counting and totaling.
x) Avoids the constant questioning and controversy about the effective fairness of the vote counting system currently in force (used until the last election in 2020—in some countries) allowing the full audit of the same by any person/party at any stage of the vote counting.
xi) Allows the effective recount of votes, either manually or electronically, in cases of suspected fraud so that the candidate who in fact obtained the highest number of valid votes will be sworn in, and in addition to preserving the physical ballot it also preserves the image of each original completed voting ballot.
xii) The various physical ballots models (see figures attached) with this presented innovation allows them to be adapted to the voter's profile and to the minimization of eventual reading errors by the system, but what makes it unique and innovative is the assignment of a unique numbering/coding to it, that allows the minimization of frauds, allows physical or electronic recount of votes, and auditing of the entire electoral system.
xiii) This innovative physical voting ballot significantly increases the credibility of the electoral process and allows the full exercise of democracy.

### 7. FIGURES, DRAWINGS, AND IMAGES OF THE INVENTION

Below, we describe the contents of the figures/drawings/images that exemplify some of the physical ballot options for paper voting or other suitable physical material, some figures/images on screen for monitoring of the voting system and more below we can see each of the figures/drawings/images with their respective numbers.

FIG. 1—VOTING BALLOT STILL ‘BLANK’ FOR MARKING IN CHARACTERS (Not yet completed by voter) containing some of the possible identification codes of the voting ballot (- - - the dotted line demarcates the access ‘window’ for voter to mark/write his/her vote - - - )

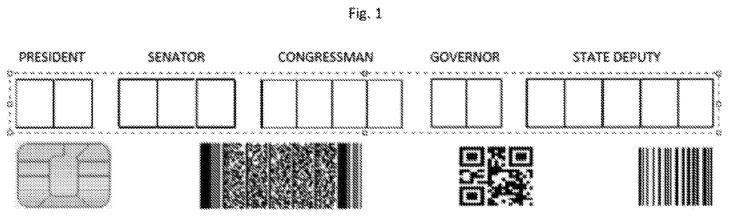

FIG. 2—VOTING BALLOT ALREADY CONTAINING THE VOTE (HAND) COMPLETED BY THE VOTER.

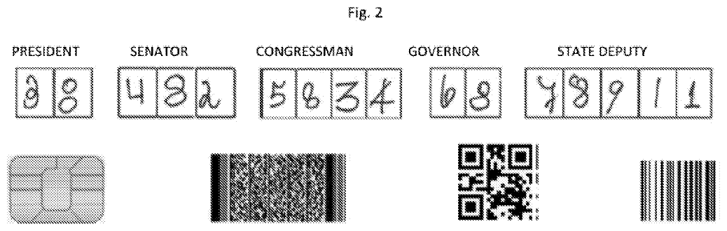

FIG. 3—VOTING BALLOT CONTAINING THE (HAND) COMPLETED VOTE BY THE VOTER AND THE UNIQUE SINGLE CODE/NUMBER ASSIGNED/PRINTED BY THE SYSTEM IN THE BALLOT THROUGH THE PRINTER INSIDE THE POLLING BOOTH.

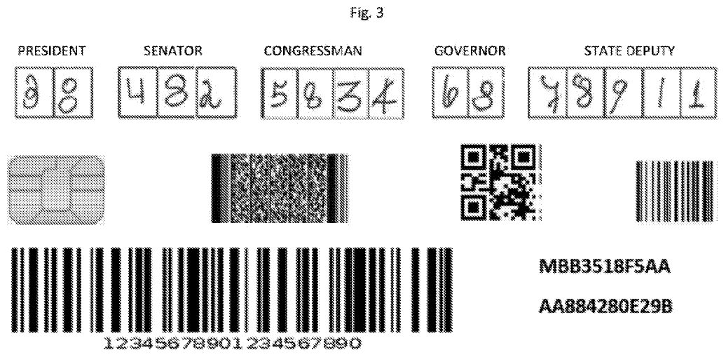

FIG. 4—VOTING BALLOT CONTAINING THE VOTE (HAND) COMPLETED BY THE VOTER, THE UNIQUE NUMBER/CODE ASSIGNED/PRINTED BY THE SYSTEM ON THE BALLOT AND ALSO CONTAINING THE VOTE ELECTRONICALLY READ AND PRINTED MECHANICALLY/ELECTRONICALLY ON THE VOTING BALLOT.

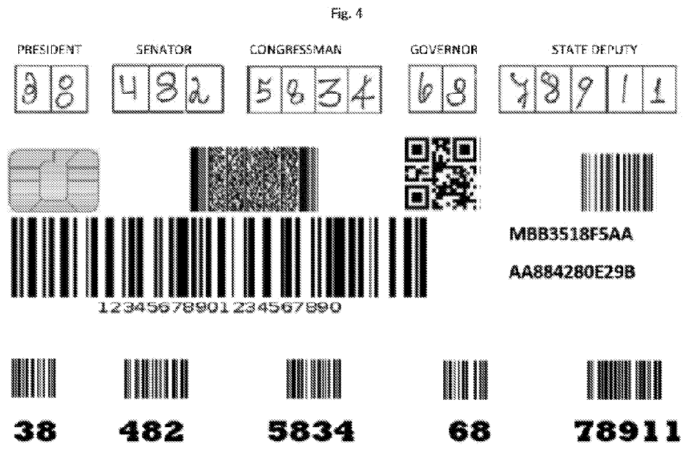

FIG. 5—IMAGE ON THE MONITOR IN THE POLLING BOOTH SHOWING THE PICTURES OF THE CANDIDATES CHOSEN BY THE VOTER AND REQUESTING HIM/HER TO CONFIRM THEM.

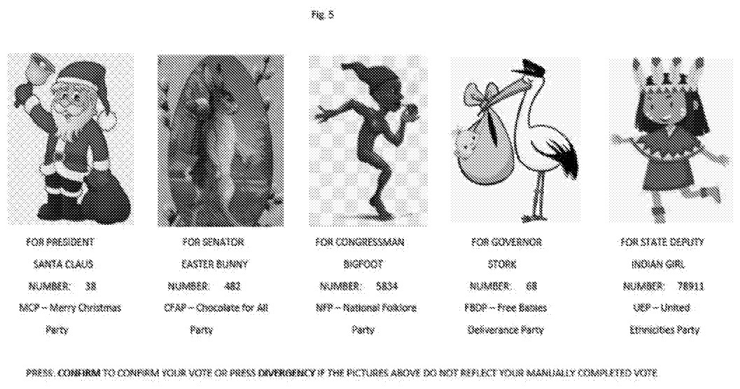

FIG. 6—VOTING BALLOT CONTAINING THE VOTE (HAND) COMPLETED BY THE VOTER, THE UNIQUE CODE ASSIGNED/PRINTED BY THE SYSTEM IN THE BALLOT AND ALSO CONTAINING THE VOTE READ AND PRINTED ELECTRONICALLY IN THE VOTING BALLOT (POSSIBLY CONTAINING AN ELECTRONIC VOTE READING ERROR OF THE HAND COMPLETED VOTE).

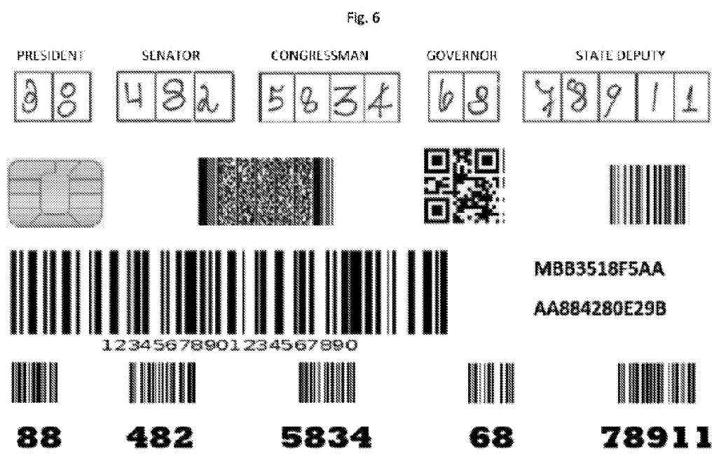

FIG. 7—IMAGE ON THE MONITOR IN THE POLLING BOOTH SHOWING THE PICTURE OF CANDIDATES CHOSEN BY THE VOTER, CONTAINING POSSIBLE READING ERRORS AND ELECTRONIC PRINTING, REQUESTING THE VOTER TO CONFIRM HIS (HER) VOTE.

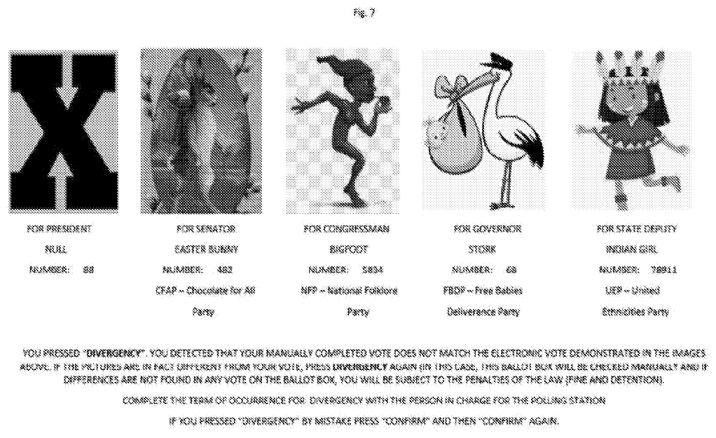

FIG. 8—ANOTHER PHYSICAL BALLOT OPTION TO BE ADOPTED DURING THE VOTING-BALLOT STILL ‘BLANK’ FOR MARKING IN PREVIOUS NUMBERS (AS SOME USED LOTTERY FLYERS)

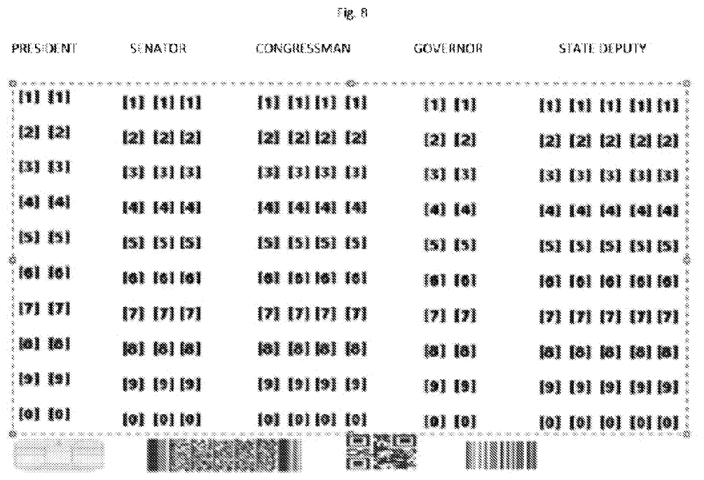

Containing some of the possible identification codes of the voting ballot (not yet hand filled in by the voter)

(- - - the dotted line demarcates the access ‘window’ for voter to mark/write his (her) vote - - - )

FIG. 9—PAPER VOTING BALLOT CONTAINING THE VOTE MARKED BY THE VOTER, THE UNIQUE CODE ASSIGNED/PRINTED BY THE SYSTEM ON THE SAME BALLOT AND ALSO CONTAINING THE VOTE ELECTRONICALLY READ AND MECHANICALLY/ELECTRONICALLY PRINTED ON THE VOTING BALLOT

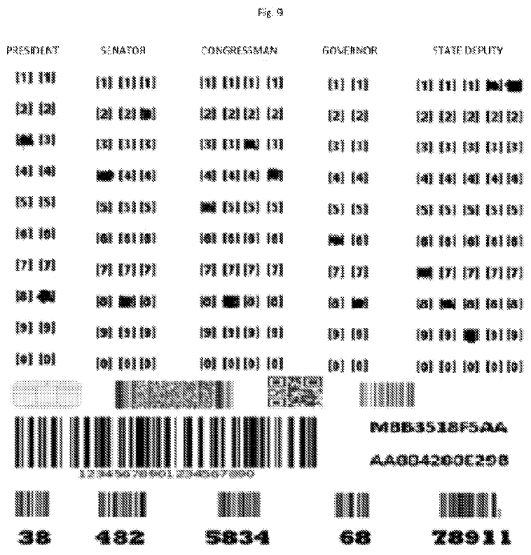

1. Product
Physical voting ballot with individual and unique numbering/coding, characterized by containing one or more tags encrypted or preprinted on it before being used in the electoral process, and a numbering and/or identification coding individual and unique, printed during the election process together with the printed coded vote of the voter.

2. Process
Physical voting ballot with individual and unique numbering/coding characterized by a process of physical treatment of the physical ballot and it's contained information that allows automated control for releasing the physical ballot for voting, automated control for receiving the voter's vote marked on it and other encoded and/or encrypted information on it, additionally automated control for capturing images and miscellaneous information, and automated control for depositing the completed physical ballot in the ballot box for already completed ballots.
